(19) United States
(12) Patent Application Publication
(10) Pub. No.: US 2024/0149738 A1
(43) Pub. Date: May 9, 2024

(54) METHOD FOR OPERATING A MOTOR VEHICLE CONFIGURED AS AN ELECTRIC OR HYBRID VEHICLE, AND THE MOTOR VEHICLE

(71) Applicant: AUDI AG, Ingolstadt (DE)

(72) Inventors: Dirk BÄDER, Fellbach (DE); Michael GRABOWSKI, Ingolstadt (DE)

(21) Appl. No.: 18/504,857

(22) Filed: Nov. 8, 2023

(30) Foreign Application Priority Data
Nov. 9, 2022 (DE) 102022129540.0

(51) Int. Cl. B60L 53/66; B60W 60/00; G06V 20/58

(52) U.S. Cl. CPC B60L 53/66; B60W 60/001; G06V 20/58; B60W 2420/42; B60W 2420/52; B60W 2420/54

(57) ABSTRACT

A method for operating a motor vehicle configured as an electric or hybrid vehicle during its charging process, including: generating a charging signal by the motor vehicle, such that the charging signal indicates an imminent charging of the motor vehicle taking place at a charging station; detecting the charging signal by a control device; detecting at least one presence information item once the charging signal has been detected by way of at least one sensor of the motor vehicle, such that the presence information item relates to the presence or absence of at least one stranger located in a vicinity of the motor vehicle; checking for the fulfillment of an action condition by way of the control device, such that the action condition is fulfilled if the presence information item verifies that a stranger is present; generating and outputting at least one control signal by the control device.

### BACKGROUND

### Technical Field

Embodiments of the invention relate to a method for operating a motor vehicle configured as an electric or hybrid vehicle during its charging process.

### Description of the Related Art

Electric or hybrid vehicles comprise a traction battery for storing electric energy intended for the propulsion of the motor vehicle. Since the storage capacity of traction batteries is limited, there is a need, especially during long trips, to interrupt the travel and charge the motor vehicle. For this purpose, stationary charging stations are available. The drawback here is the circumstance that charging stations are often situated at locations which may cause discomfort and safety concerns on the part of the occupant of the motor vehicle, especially at night. Therefore, it is desirable to heighten the safety in connection with the charging of motor vehicles.

Thus, for example, WO 2013/164 395 A2 discloses a concept in which the occupant is able to bypass an immobilizer present during the charging process. In particular, it is provided that, in the event of such a bypassing, an automatic ejecting of the charging plug occurs, so that the occupant can drive away at once.

A concept in which corresponding countermeasures are initiated in a parked motor vehicle in the presence of an alarm condition is known from US 2018/0 037 193 A1.

### BRIEF SUMMARY

Embodiments of the present disclosure may provide an improved concept in connection with a charging process of a motor vehicle, especially in regard to heightened safety.

Some embodiments may include a method of the aforementioned kind in that it involves the following steps:
generating of a charging signal by the motor vehicle, wherein the charging signal indicates an imminent charging of the motor vehicle taking place at a charging station;
detecting of the charging signal by a control device;
once the charging signal has been detected, detecting of at least one presence information item by way of at least one sensor of the motor vehicle, wherein the presence information item relates to the presence or absence of at least one stranger located in the vicinity of the motor vehicle;
checking for the fulfillment of an action condition by way of the control device, which is adapted for this, wherein the action condition is fulfilled if it is verified from the presence information item that a stranger is in fact present; and
generating and putting out of at least one control signal by the control device having the effect of lessening the danger presented by the stranger.

The charging signal may indicate the imminent charging of the traction battery of the motor vehicle taking place at a charging station. The generating of the charging signal occurs when the occupant or a controller of the motor vehicle, which is adapted to carry out its autonomous driving operation, intends to perform a charging of the traction battery at a charging station and this charging is immediately forthcoming. The generating of the charging signal on the part of the motor vehicle may occur on the part of the occupant or may automatically occur on the part of the motor vehicle. Once the charging signal has been generated, it may be detected on the part of the control device. The charging signal may be generated on the part of the control device, so that the generating is tantamount to the detecting.

The control device may be a component of the motor vehicle. The control device may be a component external to the motor vehicle and be present, for example, on the side with the charging station or as a server or central computer external to the motor vehicle.

The presence or the detecting of the charging signal may trigger the detecting of the presence information item. For this purpose, sensor data may be detected on the part of the motor vehicle, constituting the presence information item or making it possible to determine the presence information item, especially by way of the control device. The presence information item may indicate at least whether a stranger is currently present in the vicinity of the motor vehicle in which the charging is taking place at the charging station. The vicinity may be defined as the parking lot where the charging is taking place. The vicinity may be defined as a region within a given minimum distance from the motor vehicle, for example, having a radius between 10 meters and 200 meters.

Regarding the stranger, a heightened danger potential always exists basically when someone is presently located in the vicinity of the motor vehicle. Thus, the possibility exists that the stranger has bad or criminal intent, so that the danger potential is always heightened whenever the stranger is present in the vicinity. Thus, the occupant of the motor vehicle currently connected to the charging station typically represents an easy victim for a theft or an assault or the like, especially at deserted parking lots or in dark industrial districts. Hence, the action condition is fulfilled if the stranger stays in the vicinity or proximity of the motor vehicle and has been detected accordingly.

The method and motor device disclosed herein are based in particular on the idea that, in event of the presence of the stranger in the vicinity, a measure is taken which lessens the danger potentially coming from the stranger. For this, the control device may generate and output the control signal, which triggers corresponding deterrence and/or defense measures, as shall be explained in detail in the following.

The detecting of the presence information item and the checking for the fulfillment of the action condition may occur continuously. That is, the presence information item may be detected or updated in cycles, so that changing circumstances in regard to the danger potential may also be considered even during the charging of the motor vehicle.

The charging signal may be generated by the user of the motor vehicle through an input device of the motor vehicle. The input device of the motor vehicle may be, for example, a touchscreen and/or an audio recording device with properly implemented speech recognition. In the case of a touchscreen, the occupant may press a button whereupon the charging signal is generated and sent to the control device. The button may have the label “Battery is about to be charged”.

In some embodiments, the charging signal may be generated by the control device of the motor vehicle or by another control device, which is adapted to carry out an autonomous driving operation of the motor vehicle. Thus, in the context of carrying out the autonomous driving operation, a low state of charge of the traction battery may be recognized, whereupon the map data of a navigation system of the motor vehicle may be searched to find a charging station in the vicinity and the vehicle may be driven automatically to this station. The charging signal may be generated automatically in this case. The control device of the motor vehicle or the further control device may be adapted in particular to perform a fully autonomous driving operation of the motor vehicle, so that no further involvement of the occupant is required for the longitudinal and transverse control of the motor vehicle and instead the occupant may work, use the infotainment system of the motor vehicle, or sleep.

Upon detecting of the charging signal by the control device, at least one illumination signal may be generated and output, the illumination signal may be sent to at least one lighting device of the motor vehicle, by way of which the brightness in the vicinity is increased when the illumination signal is present. Thus, if the charging of the motor vehicle is immediately forthcoming, an illumination of the vicinity may be generated by way of the lighting device. On the one hand, this illumination may create a better database in regard to the detecting of the presence information item, since the corresponding data, especially image data, will have a better quality under stronger illumination. Furthermore, this measure may strengthen the feeling of safety on the part of the occupant, since they can better see the previously dark charging location. Moreover, this measure may deter any strangers with criminal intent and they may take flight on account of the higher level of illumination. The illumination signal may be the control signal generated upon fulfillment of the action condition, which will be further discussed in detail.

The lighting device may be situated, for example, at the front or rear or at the side, especially beneath a side mirror, on the motor vehicle. Light may be generated by way of the lighting device. The lighting device may be a front headlight, a reversing light, or a side light of the motor vehicle. Multiple lighting devices may be activated with the illumination signal, so that the increased brightness in the vicinity occurs on all sides of the motor vehicle.

In connection with the generating and output of the illumination signal, brightness information may be detected, for example, by way of a brightness sensor of the motor vehicle. The brightness information may relate to the brightness currently present in the vicinity. The brightness sensor may be a camera of the motor vehicle. The illumination signal may only be generated and output if the brightness information indicates that the brightness present in the vicinity is less than a predetermined brightness limit value. Thus, an increasing of the brightness in the vicinity is feasible, such as during dusk or at night, especially when there are no stationary lighting devices, such as street lamps, present at the charging location.

In some embodiments, upon detecting of the charging signal, a wireless communication link may be established between a communication device of the motor vehicle and a communication device of the charging station. An authentication of the occupant of the motor vehicle may be performed via the communication link in order to enable the charging process. Thus, an authentication of the occupant may be required prior to the charging process, for metering and payment purposes. The occupant must often leave the motor vehicle for this purpose and enter the corresponding data through an operator terminal of the charging station or provide it by way of a charge card. However, this step may be carried out by the wireless communication link as described herein, without the occupant having to leave the motor vehicle and without having to unlock it.

The wireless communication link may be designed with near field communication technology based on, for example, NFC, radio, or Bluetooth. A remote communication technology be included in some embodiments such as, for example, through the Internet, an external server, or the like. The steps necessary for the authentication, i.e., the corresponding operator input and/or data transmission in particular, may be done by way of an application installed on a Smartphone of the occupant.

In some embodiments, a method may be provided including upon detecting of the charging signal, at least one initiation signal may be generated and output, wherein the initiation signal
may be sent to at least one electromechanical actuator of the charging station, by way of which an automatically occurring connection of a charging interface of the charging station to a charging interface of the motor vehicle occurs when the initiation signal is present, and/or
may be sent to at least one electromechanical actuator of the motor vehicle, by way of which an automatically occurring opening of a cover closing a charging interface of the motor vehicle, especially a cover in the form of a flap, is done when the initiation signal is present.

Such a method does not require the occupant to exit from the motor vehicle for its charging in order to manually insert a charging plug of the charging station. Instead, the connecting of the motor vehicle to the charging station occurs automatically and no active involvement of the occupant is required for this. This process may occur if the authentication has been performed successfully.

In some embodiments, the charging plug may be brought by way of a robot arm of the charging station, which comprises the actuator or is coupled to it, up to the motor vehicle or a charging socket of the motor vehicle. The side with the charging station or the robot arm may include sensors, such as a camera and/or a distance sensor, and the corresponding sensor data may be used for the automated producing of the connection. The initiation signal and/or corresponding control signals may be generated on the side with a control unit of the charging station or on the side with the control device.

In some embodiments, the initiation signal may be generated and output upon detection of the charging signal, such as on the side with the control device, and the initiation signal may be sent to the actuator of the motor vehicle, thereby initiating an automatic opening of the cover. The actuator may be operatively connected to allow such automatic opening of the cover.

The sensor for detecting the presence information item may be a camera for the detection of optically visible light, a thermal image camera for detection of infrared light, an ultrasound sensor, a lidar sensor, and/or a radar sensor. In some embodiments, further sensors may be provided for detecting the presence information item. The sensor signals of such sensors may be suitable for detecting the presence of the stranger. Preferably, the sensor signals of several of the sensors are evaluated, such as those on the part of the control device, so that the generating of the presence information item relies on an even better database. Notably, the sensor data of different sensors may mutually supplement each other and/or be used for a corresponding verification.

In some embodiments, various control signals may be output, and a degree of criticality is determined with the aid of the presence information item and/or at least one further additional information item regarding the vicinity of the motor vehicle and/or the stranger, indicating a measure of the current danger potential, such that the control signal output is determined as a function of the degree of criticality. The additional information item may relate to specific viewpoints with respect to the vicinity and/or the stranger, and the probability of an endangerment being present can be determined on this basis. The degree of criticality may thus be higher as this probability is higher. The detecting of the additional information item may be done by way of sensor data of the sensor of the motor vehicle, such as the camera, the thermal image camera, the ultrasound sensor, the lidar sensor, and/or the radar sensor. Instead of determining the degree of criticality, the performing of this determination may be proposed to the occupant, such as through the input device, and the occupant may then initiate or reject this step. Multiple possible steps may be displayed to the occupant, who may then select which of these steps to carry out. This involvement on the part of the occupant may be bypassed if a high degree of criticality is currently at hand.

Therefore, the mere presence of a stranger, from whom possibly no danger is presented, resulting in the generating of the control signal and the initiating of corresponding steps may be prevented. The control signals which may be output can produce different drastic steps, and a drastic step being initiated for a rather low degree of criticality may be prevented. The choice of the control signal output may therefore be situation-specific. The steps initiated may be more drastic as the degree of criticality is higher.

The degree of criticality may be a numerical value on a given scale, where a low numerical value implies a low danger potential and a high numerical value a high danger potential. For example, the degree of criticality may take on integer numerical values between a minimum value, amounting to 0 for example, and a maximum value, amounting to 3 for example, where the minimum value signifies a slight or no danger potential present and the maximum value an extremely high danger potential.

The at least one additional information item may be position information regarding the current position of the motor vehicle. The position information may be detected by way of a navigation device of the motor vehicle or it may be predetermined. The degree of criticality may be increased when the position information indicates that the motor vehicle is located at present in a vicinity with increased danger potential. This is the case, for example, when there have already been frequent criminal assaults in the past in the present vicinity according to experience.

The at least one additional information item may be time information regarding the time of day. The time information may be detected by way of a clock of the motor vehicle and/or it can be provided via the communication link. Thus, typically, it may be assumed that assaults take place primarily in the evening or at night, so that the degree of criticality may be increased when the time information reveals such to be the case.

The at least one additional information item may be brightness information regarding the current brightness. The brightness information may be detected by way of the brightness sensor of the motor vehicle or a brightness sensor, or it may be predetermined. Thus, it may typically be assumed that assaults take place primarily in darkness or at dusk, so that the degree of criticality may be increased when the brightness information reveals such to be the case.

The at least one additional information item may be personal information. The personal information may be determined by way of an image evaluation software or it may be predetermined. The personal information may relate to the gender and/or the stature of the stranger. Thus, it may typically be assumed that a higher danger potential occurs from a male and powerful or adult stranger than from a little girl, so that the degree of criticality may be increased when the personal information reveals such to be the case.

The personal information may pertain to an object carried by the stranger. Thus, the degree of criticality may be increased, such as to the maximum value, when the stranger is carrying a dangerous object, such as a weapon. The personal information may pertain to the clothing of the stranger. For example, the degree of criticality may be increased if the stranger is wearing suspicious clothing, such as clothing having prohibited insignia or those pointing to criminal organizations.

The at least one additional information item may be relative position information pertaining to the relative position between the motor vehicle and the stranger, which may be determined, for example, with the aid of sensor data of the camera, the lidar, the radar sensor, or which is predetermined. Thus, it may be assumed that the danger potential is higher for a stranger the closer he is to the motor vehicle and/or the greater the speed with which he is approaching the motor vehicle. Thus, the degree of criticality may be increased accordingly when the stranger is closer than a given distance limit value to the motor vehicle and/or when the stranger is approaching the motor vehicle with greater speed than a given speed limit value. The speed of the stranger may be determined with the aid of consecutively detected relative position information.

The at least one additional information item may be activity information regarding the current activity of the stranger with respect to the motor vehicle. Thus, the activity information may imply, for example, that the stranger is touching the motor vehicle and/or is trying to gain entry to the motor vehicle. In such cases, an immediate threat situation may be assumed, and the degree of criticality may be set at the highest value. At least one touch sensor of the motor vehicle may be provided for detecting the activity information. The activity information may be determined with the aid of the relative position information, whereby the activity information indicates an action of the stranger on the motor vehicle when it results from the relative position information that the distance between the motor vehicle and the stranger is zero.

In some embodiments, the control signal may be sent to at least one output device of the motor vehicle, by way of which an acoustical and/or optical warning may be output to the occupant and/or to the stranger when the control signal is present. For example, for a low degree of criticality, the warning given to the occupant may be the text “Stranger present in the vicinity” and/or a camera image in which the position of the stranger is marked or highlighted in particular is output. For a higher degree of criticality, red blinking text “Stranger may threaten you” and/or a warning tone, for example, may be output to the occupant.

In an event of a correspondingly high degree of criticality a warning may be output to the stranger, for example, through an acoustical message. In some embodiments, spoken text may be output as the warning message. Some embodiments may include the output of alarm sounds, such as a cyclical horn or the like. These warnings may have a deterrent effect on the stranger causing him to move away from the motor vehicle.

The control signal may be sent to the communication device of the motor vehicle, to a communication device, or to a further communication device, by way of which an emergency call is made automatically to a security company, a police authority, and/or at least one vehicle located in the vicinity of the motor vehicle when the control signal is present. As active assistance is requested in such situations, this step may be taken when there is a correspondingly high degree of criticality. Furthermore, information may be output to the occupant through the output device, for example, to the effect that an emergency call has been made automatically.

The control signal may be sent to the control device of the motor vehicle or to a further control device, which is adapted to carrying out an autonomous driving operation of the motor vehicle, by way of which a movement of the motor vehicle is automatically performed when the control signal is present. This step may be initiated at a correspondingly high degree of criticality. The motor vehicle may be moved such that it automatically moves away from the charging location. Such movement may require an appropriate departure release on the part of the occupant in advance.

The control signal may be sent to a separation device of the motor vehicle, by way of which an unlocking and/or a separating of the connection between the motor vehicle and the charging station is automatically performed when the control signal is present. In order to avoid damage in the event of an escaping of the motor vehicle when it is connected to the charging station, it may be necessary to release the corresponding connection. As a result of the automatic unlocking or separating, the occupant need not first get out of the motor vehicle and manually release the charging plug before the vehicle drives away.

The separation device may comprise an electromechanical separation device actuator or is designed as such, and when the control signal is present the separation device actuator is actuated such that an automatic ejecting of the charging plug of the charging station from the charging socket of the motor vehicle occurs. The separation device may comprise at least one ejection pin arranged in the area of the charging socket, which, when the separation signal is present, may be moved along its longitudinal direction against the charging plug, in order to push it automatically out of the charging socket.

In place of the separation device, there may be at least one magnet in the area of the charging interfaces, which holds the charging plug in position in the charging socket. Thus, the motor vehicle may likewise make its escape without damaging the charging interfaces and/or the charging cable, since the force resulting from the driving away of the motor vehicle automatically brings about a releasing of the connection formed through the magnet.

In some embodiments, a motor vehicle, configured as an electric or hybrid vehicle, may generate a charging signal indicating an imminent charging of the motor vehicle taking place at a charging station, wherein at least one sensor of the motor vehicle may detect at least one presence information item relating to the presence or absence of at least one stranger located in the vicinity of the motor vehicle, wherein the motor vehicle comprises a control device which is adapted to carry out the method as described herein. All benefits and features explained in connection with the method described herein may be applied equally to the motor vehicle described herein.

### BRIEF DESCRIPTION OF THE SEVERAL VIEWS OF THE DRAWINGS

FIG. 1 shows a vicinity of a motor vehicle, in which a charging station and a stranger are located.

FIG. 2 shows a flow chart of a method of charging the motor vehicle of FIG. 1.

FIG. 3 shows a cross-sectional view through a charging socket of the motor vehicle of FIG. 1, into which a charging plug of the charging station has been inserted.

FIG. 4 shows a cross-sectional view through a charging socket of the motor vehicle of FIG. 1, into which a charging plug of the charging station has been inserted.

### DETAILED DESCRIPTION

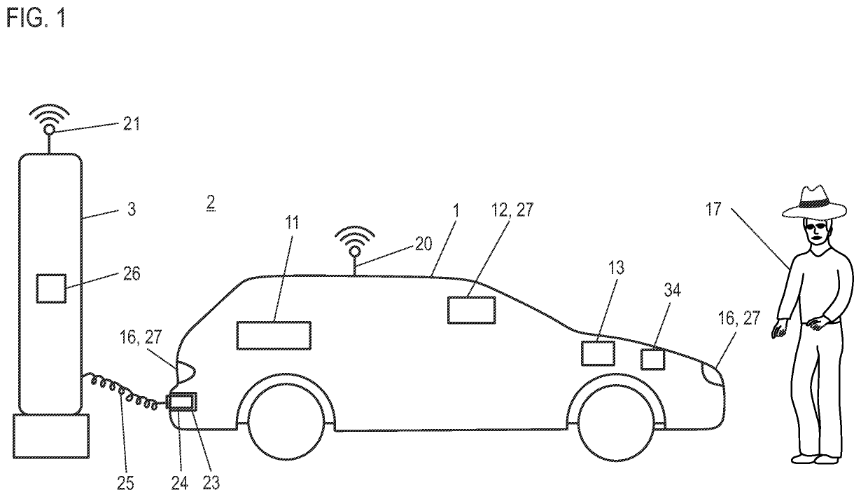

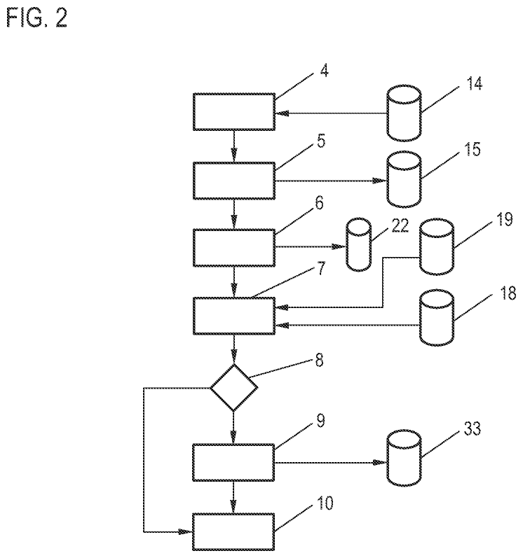

FIG. 1 shows a motor vehicle 1 according to an embodiment, where the motor vehicle 1 finds itself in a vicinity 2, being in the present case a parking lot having a charging station 3. In the following, a method will be explained according to an exemplary embodiment with the aid of FIGS. 1 and 2, where FIG. 2 shows a corresponding flow chart of the method and this method may be carried out for the motor vehicle 1 shown in FIG. 1. The method involves the steps 4-10.

The method relates to the operation of the motor vehicle 1, configured as an electric or hybrid vehicle, during its charging process. The motor vehicle 1 may comprise traction battery (not shown), in which electric energy can be stored and used for propulsion of the motor vehicle 1. The starting point for the method shown in FIG. 2 may be that the traction battery of the motor vehicle 1 is in a state requiring a charging and for this purpose it drives to the vicinity 2 with the charging station 3.

In the first step 4 of the method, a charging signal 14 may be generated on the part of the motor vehicle 1, indicating a forthcoming charging of the motor vehicle 1 or its traction battery taking place at the charging station 3. The generating of the charging signal 14 may occur on the part of a control device 11 of the motor vehicle 1, which is adapted to carry out an autonomous driving operation of the motor vehicle 1. Thus, the driving operation of the motor vehicle 1 may occur, for example, fully autonomously, so that no involvement of the occupant of the motor vehicle 1 is required for its longitudinal or transverse guidance. In some embodiments in which the motor vehicle 1 is being driven by the occupant, the charging signal may be generated on the part of the occupant through an input device 12 of the motor vehicle 1. The input device 12 may be a touchscreen, and the occupant may press a button with the label “Charge battery” for the generating of the charging signal. In any case, the charging signal may be detected on the part of the control device 11.

The control device 11 may be adapted to carry out the method disclosed herein. In some embodiments, a central computer or server external to the motor vehicle may be included in place of the control device 11, while a corresponding communication link may be formed between the motor vehicle 1 or its control device 11 and the central computer or server.

In the second step 5 of the method, brightness information regarding current brightness present in the vicinity 2 may be detected by way of a sensor 13 of the motor vehicle 1. The sensor 13 may be a camera of the motor vehicle 1. If the brightness information indicates that twilight or night is prevailing at the moment in the vicinity 2, an illumination signal 15 may be generated and output after the detecting of the charging signal 14. The illumination signal 15 may be sent to lighting devices 16 of the motor vehicle, namely, to a front headlight, to a reversing light, and to side lights of the motor vehicle 1. By way of the illumination signal 15, the lighting devices 16 may be activated so that they generate light and bring about an increased brightness in the vicinity 2. The increased brightness may have the effect, on the one hand, that the occupant can better view the vicinity 2 and can break off the charging process, for example, if a dubious person 17 is present in the vicinity 2 during the approach to the charging station 3 and drive to another charging station. Furthermore, the increased brightness may enable a better detecting of a presence information item 18 as well as an additional information item 19, which are yet to be detected.

In the third step 6 of the method, upon detection of the charging signal 14, a wireless communication link may be produced between the motor vehicle 1 and the charging station 3, namely, through a communication device 20 of the motor vehicle 1 and a communication device 21 of the charging station 3. The communication link may be produced by a NFC, a radio, or a Bluetooth connection, i.e., by way of a near field communication. In some embodiments, the communication link may be produced by way of a remote communication, which may be established, for example, through the Internet or a server or central computer. In place of the communication device 20 of the motor vehicle 1, a communication device of a smartphone of the occupant may be provided, on which a corresponding application is implemented. Through the communication link, an authentication of the occupant may occur in order to allow the charging process. Data regarding the identity of the occupant may be relayed through the communication link, as may be required for payment and accounting purposes.

Furthermore, the generating and output of initiation signals 22 may occur in the course of step 6. An initiation signal 22 may be generated on the part of the control device 11 and output to an electromechanical actuator (not shown) of the motor vehicle 1, and then a covering (not shown), which covers a charging socket of the motor vehicle 1, may be opened.

In some embodiments, the initiation signal 22 may be generated on the part of a control unit 26 of the charging station 3 and output to an electromechanical actuator (not shown) of the charging station 3 by way of which a connecting of a charging interface 24 of the charging station 3 to a charging interface 23 of the motor vehicle 1 occurs automatically. A charging socket may be provided as the charging interface 23 of the motor vehicle 1 and a charging plug of a charging cable 25 of the charging station 3 may be provided as the charging interface 24 of the charging station 3. The charging plug may be inserted automatically into the charging socket. For this purpose, the charging station 3 may comprise a robot arm (not shown) by way of which the charging plug is brought to the charging socket and inserted therein. The robot arm may comprise sensors, such as a camera and a distance sensor, and the corresponding sensor data may be relayed for evaluation to the control unit 26.

In the fourth step 7 of the method, the presence information item 18 may be determined by way of several sensors 13 of the motor vehicle 1. The sensors 13 may be any of the already mentioned camera, a thermal image camera, an ultrasound sensor, a lidar sensor, and a radar sensor. The corresponding sensor data may be sent to the control device 11, by which the corresponding evaluation of the sensor data is done to determine the presence information item 18.

The presence information item may indicate whether the stranger 17 is present at the moment in the vicinity 2 of the motor vehicle 1. Corresponding camera images may be evaluated, for example, by way of the control device 11 through image evaluation software.

Furthermore, the additional information items 19 may be determined in the course of step 7. The additional information item 19 may include position information regarding the current position of the motor vehicle 1 determined by a navigation system of the motor vehicle 1. The additional information item 19 may include time information regarding the current time of day provided by a clock of the motor vehicle 1. The additional information item 19 may include the already explained brightness information. The additional information item 19 may include personal information regarding any of gender, stature, any object carried by the stranger 17, and clothing of the stranger 17. The additional information item 19 may include relative position information, detected by way of the sensors 13, indicating a relative position between the motor vehicle 1 and the stranger 17. The additional information item 19, may include any action performed by the stranger 17 on the motor vehicle 1. The activity information may indicate that the stranger 17 is touching the motor vehicle 1 or attempting to gain entry to it, especially forcefully.

In the next step 8 of the method, the fulfillment of an action condition may be checked by way of the control device 11, wherein this condition is fulfilled if results from the presence information item 18 indicate the stranger 17 is currently present. If the checking of the fulfillment of the action condition in step 8 has revealed that the stranger 17 is not currently present, the method is ended in the last step 10.

If the action condition is fulfilled, a degree of criticality may then be determined with the aid of the additional information item 19, indicating a measure for a current danger potential presented by the stranger 17. For example, some embodiments employ integer degrees of criticality from 0 to 3, the danger potential being higher with increasing value of the degree of criticality. For example, the degree of criticality may be 0 when it emerges from the presence information item 18 and the additional information items 19 that the current position of the motor vehicle 1 is a thronged parking lot, the current time of day is noon, the stranger 17 is a little girl, and it emerges from the relative position information that the stranger 17 is not in the immediate vicinity of the motor vehicle 1 nor are they coming any closer. The degree of criticality, on the other hand, may reach the maximum value, for example, when it emerges from the presence information item 18 and the additional information items 19 that the motor vehicle 1 is currently in a lonely parking lot at night, where criminal assaults have already often occurred in the past, while the dark clothed stranger 17 is a man of powerful build having a dangerous object, being located in the immediate vicinity of the motor vehicle 1 and is possibly approaching it with relatively high speed. This approaching or the corresponding speed of the stranger 17 may be determined from a sequence of consecutively detected relative position information items.

Regarding the steps 7 and 8, it should be noted that they may be carried out continuously during the overall course of the method, such that the information items 18, 19 may constantly be updated.

Upon fulfillment of the action condition and after determining the degree of criticality, in the next step 9 of the method a control signal 33 may be generated and output. The control signal 33 may be configured to bring about a lessening of the danger coming from the stranger 17. Various control signals 33 may be output, and which of the possible control signals 33 will be output may be determined with the aid of the degree of criticality. Several possible scenarios in this regard will be explained in the following. In some embodiments, if the determination of the degree of criticality is not carried out in the method as described above, several possible steps may be displayed to the occupant and the occupant may then select which of these steps should be carried out. This involvement on the part of the occupant may be bypassed if a high degree of criticality exists at the time.

If the degree of criticality reveals that a low danger potential is currently present, the control signal may be sent to an output device 27 of the motor vehicle 1, which in some embodiments may be the already mentioned touchscreen, such that the occupant is shown camera images of the vicinity 2, with the position of the stranger 17 marked or highlighted on the camera image shown. The occupant may then decide whether he wants to begin or continue with the charging process despite the presence of the stranger 17.

If the degree of criticality reveals that a medium danger potential is currently present, the control signal 33 may be sent to the output device 27, such that a specific, acoustical and/or optical warning message will be output to the occupant. This warning message may inform the occupant that the stranger 17 is approaching the motor vehicle 1 or is present in the immediate vicinity of the motor vehicle 1. In some embodiments, a corresponding control signal 33 may be sent to a further output device 34 of the motor vehicle 1, by way of which an acoustical and/or optical warning will be output to the stranger 17. For example, at least one acoustical warning message such as, “Attention! This is a vehicle which is in police alert mode. Approach is not wanted. Please respect this and move away!,” “Video and audio recording started!,” “Transmission to service and control centers started!,” “If you come within three meters of the motor vehicle the police will be alerted!,” or the like, may be output to the stranger 17. As an optical warning to the stranger 17, and in order to make any other persons present in the vicinity aware of the endangerment, the control signal 33 may be sent to the lighting device 16 as the output device 27, generating, for example, an optically conspicuous warning blinker and/or pulsating high beams and low beams or brake lights. Furthermore, a horn of the motor vehicle 1 may be activated as the output device 27, such that a corresponding acoustical burglar alarm or a siren sound is generated.

If the degree of criticality takes on a high or very high value, the control signal 33 may be relayed to the communication device 20 of the motor vehicle 1, and an emergency call may be made automatically to a security company and/or a police authority. Furthermore, corresponding camera images and sound recordings may be relayed to the respective security company and/or police authority. Optionally, the voice of a person at the security company and/or police authority may be output to the occupant and/or the stranger 17. By way of the communication device 20, corresponding messages may be sent via so-called car-to-car connections to vehicles located in the vicinity of the motor vehicle 1, such that other road users can respond appropriately and cause the stranger 17 to flee. For example, the constant updating of the information items 18, 19 may show that the stranger 17 has approached the motor vehicle 1 closer than a given minimum distance of 3 meters, for example, and in such a case, control signals 33 producing the drastic steps will be output.

In some embodiments, in an event of a high degree of criticality, the control signal 33 may be sent to the control device 11 which is configured to carry out the autonomous driving operation of the motor vehicle 1, which may automatically bringing about a movement of the motor vehicle 1. For example, when the stranger 17 is carrying a dangerous object and/or when they try to make a forceful entry to the motor vehicle 1, the motor vehicle 1 may take flight at once and automatically. The movement may be a driving away of the motor vehicle 1. However, the movement may be simply a movement of the motor vehicle 1 back and forth for a short stretch, such as 1 meter. The movement in itself may be sufficient to make the stranger 17 desist from any attempts to gain entry to the motor vehicle 1.

The control signal 33, such as in the event of extremely high degree of criticality, may be sent to a separation device 28 of the motor vehicle 1, by way of which an unlocking and a separation of the connection between the motor vehicle 1 and the charging station 3 may automatically be carried out when the control signal 33 is present, such that escape is made possible for the motor vehicle 1, especially under autonomous control, without damaging the charging interfaces 23, 24 and the charging cable 25.

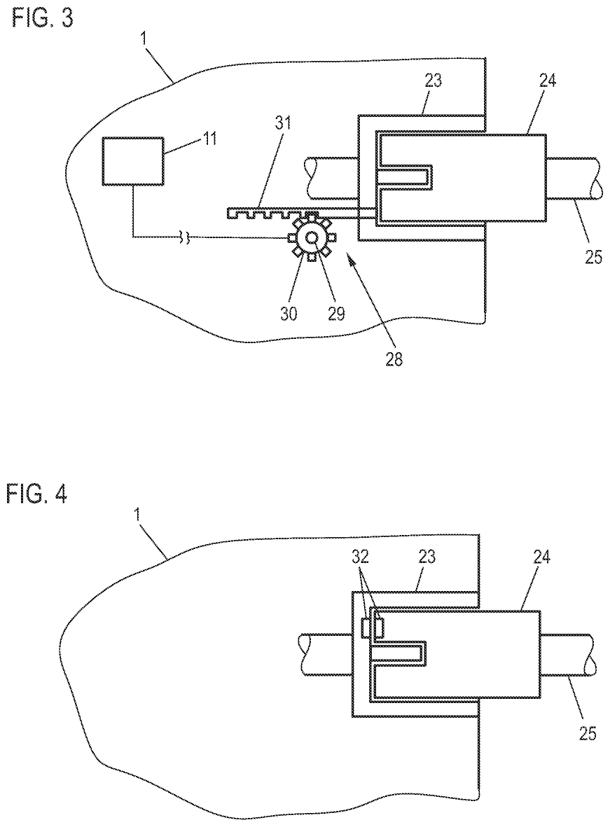

The separation device 28 is shown in FIG. 3, which is a cross-sectional view through the motor vehicle 1 in the region of the charging socket with the charging plug inserted. Thus, the separation device 28 may comprise an electromechanical separation device actuator 29 which may be activated on the part of the control device 11, and which in turn may be coupled to a gear 30 and may be configured to place the gear 30 in rotation. The gear 30 may mesh with an ejection pin 31 fashioned as a toothed rack, such that a rotation of the gear 30 causes a movement of the ejection pin 31 to the right, in terms of FIG. 3, and the charging plug may automatically be ejected from the charging socket and falls to the ground. In some embodiments, two ejection pins 31 may be provided, being situated at the same height. As soon as the charging plug has been ejected from the charging socket, the control signal 33 may be output, effectuating the movement or the escape of the motor vehicle 1.

FIG. 4 shows an alternative configuration of the motor vehicle 1, where in place of the separation device 28 there are provided magnets 32 configured to hold the charging plug in position in the charging socket. The motor vehicle 1 may make its escape without damaging the charging interfaces 23, 24 and/or the charging cable 25, since a releasing of the connection formed through the magnets 32 is automatically produced by the driving away of the motor vehicle 1, to the left in terms of FIG. 4.

German patent application no. 10 2022 129540.0, filed Nov. 9, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a motor vehicle configured as an electric or hybrid vehicle during its charging process, the method comprising:
generating a charging signal by the motor vehicle, wherein the charging signal indicates an imminent charging of the motor vehicle taking place at a charging station;
detecting the charging signal by a control device;
detecting at least one presence information item by at least one sensor of the motor vehicle after the charging signal has been detected, wherein the at least one presence information item relates to the presence or absence of at least one stranger located in a vicinity of the motor vehicle;
checking for fulfillment of an action condition by the control device, the control device being configured to check for the fulfillment of the action condition, wherein the action condition is fulfilled when the presence information item verifies a stranger is present; and
generating and outputting at least one control signal by the control device, the at least one control signal configured to lessen danger presented by the stranger.

2. The method according to claim 1, further comprising generating the charging signal by an occupant of the motor vehicle through at least one of an input device of the motor vehicle, the control device, and a second control device of the motor vehicle, the second control device configured to carry out an autonomous driving operation of the motor vehicle.

3. The method according to claim 1, further comprising:
generating and outputting at least one illumination signal upon detecting the charging signal by the control device; and
sending the illumination signal to at least one lighting device of the motor vehicle wherein a brightness in the vicinity is increased when the illumination signal is present.

4. The method according to claim 1, further comprising:
establishing a wireless communication link between a communication device of the motor vehicle and a communication device of the charging station upon detecting the charging signal; and
performing an authentication of the occupant of the motor vehicle via the communication link in order to enable the charging process.

5. The method according to claim 4, further comprising generating and outputting at least one initiation signal upon detecting the charging signal, wherein the initiation signal is sent to at least one of:
at least one electromechanical actuator of the charging station, wherein an automatically occurring connection of a charging interface of the charging station to a charging interface of the motor vehicle occurs when the initiation signal is present; and
at least one electromechanical actuator of the motor vehicle, wherein an automatically occurring opening of a cover of a charging interface of the motor vehicle is done when the initiation signal is present.

6. The method according to claim 1, wherein the sensor is at least one of a camera configured to detect optically visible light, a thermal image camera configured to detect infrared light, an ultrasound sensor, a lidar sensor, and a radar sensor.

7. The method according to one claim 1, further comprising determining a degree of criticality based on at least one of the presence information item and at least one further additional information item regarding the vicinity of the motor vehicle and/or the stranger, the degree of criticality indicating a measure of the current danger potential, wherein the control signal output is determined as a function of the degree of criticality.

8. The method according to claim 1, wherein the at least one additional information item is at least one of:
position information regarding a current position of the motor vehicle;
time information regarding a time of day;
brightness information regarding a current brightness;
personal information regarding at least one of a gender of the stranger, a stature of the stranger, an object carried by the stranger, and clothing of the stranger;
relative position information regarding a relative position between the motor vehicle and the stranger; and
activity information regarding a current action of the stranger on the motor vehicle.

9. The method according to claim 1, wherein the control signal is sent to at least one of:
at least one output device of the motor vehicle, wherein an acoustical and/or optical warning is output to at least one of the occupant and the stranger when the control signal is present;
at least one of the communication device of the motor vehicle, to a communication device, and a second communication device, wherein an emergency call is made automatically to at least one of a security company, a police authority, and at least one vehicle located in the vicinity of the motor vehicle when the control signal is present,
at least one of the control device of the motor vehicle and a second control device configured to carry out an autonomous driving operation of the motor vehicle, wherein a movement of the motor vehicle is automatically performed when the control signal is present, and
a separation device of the motor vehicle, wherein at least one of an unlocking and a separating of the connection between the motor vehicle and the charging station is automatically performed when the control signal is present.

10. The method according to claim 9, wherein the control signal is configured to cause the separating of the connection between the motor vehicle and the charging station, wherein the separation device comprises an electromechanical separation device actuator and when the control signal is present, the separation device actuator is actuated such that an automatic ejecting of the charging plug of the charging station from the charging socket of the motor vehicle occurs.

11. A motor vehicle configured as an electric or hybrid vehicle, comprising:
a control device configured to carry out the method of claim 1; and
at least one sensor configured to detect at least one presence information item relating to the presence or absence of at least one stranger located in a vicinity of the motor vehicle,
wherein the motor vehicle is configured to generate a charging signal indicating an imminent charging of the motor vehicle taking place at a charging station.
